(19) United States
(12) Patent Application Publication
(10) Pub. No.: US 2026/0326723 A1
(43) Pub. Date: Oct. 22, 2026

(54) AUTOMATED ROBOTIC VEHICLE CLEANING SYSTEM AND METHOD

(71) Applicant: Dennis Dreeszen, Denver, CO (US)

(72) Inventor: Dennis Dreeszen, Denver, CO (US)

(21) Appl. No.: 19/642,745

(22) Filed: Apr. 9, 2026

Related U.S. Application Data
(60) Provisional application No. 63/791,443, filed on Apr. 19, 2025.

(51) Int. Cl. B60S 3/04; B25J 5/02; B25J 9/16; B25J 11/00

(52) U.S. Cl. CPC B60S 3/04; B25J 5/02; B25J 9/163; B25J 9/1664; B25J 11/0085

(57) ABSTRACT

The present system pertains to a unique vehicle washing arrangement. The system utilizes a plurality of movable and articulating robotic arms to precisely position a plurality of nozzles in proximity to a vehicle and apply a washing routine to clean the vehicle. The movement and position of the robotic arms and nozzles are controlled by a computer control system that utilizes an artificial intelligence adaptive control routine and feedback from a plurality of sensors to construct a three-dimensional model of a vehicle, and simulate iterative paths for the robotic arms based on a predefined set of generic paths for cleaning the vehicle. This allows the system to confirm the appropriate specific path, unique to each vehicle before beginning the wash cycle and then quickly perform the wash cycle in close proximity to the vehicle but with no concern of damage to the vehicle.

### CROSS REFERENCE TO RELATED APPLICATIONS

This application claims priority to and incorporates by reference in its entirety and for all purposes U.S. Provisional Patent Application Ser. No. 63/791,443 filed on behalf of Dennis Dreeszen on Apr. 19, 2025.

### BACKGROUND

Conventional touchless vehicle washes use series of nozzles to spray water and detergent on vehicles in an effort to clean them. The nozzles may be fixed or move along preset tracks regardless of the vehicle being cleaned. Alternative vehicle washes use rollers or curtains of material to drag, spin, or slap against the exterior of the vehicle in connection with the application of water and detergent to wipe away dirt, oil, debris, or other unwanted components (collectively “dirt”) from the exterior of the case. The washes usually include fixed blower arches or gantry-based systems for drying, which are inefficient, noisy, and poorly adapted to vehicle shapes and attachments. These systems are often not neighborhood-friendly due to noise levels. Furthermore, they rely on multiple electric motors and require significant energy use. Alternatively or in addition, they may use a hand dry system of manually wiping down the vehicle with a rag.

These systems have significant drawbacks. Fixed systems do not adjust for the particular features of the vehicle. This can lead to inadequate coverage of washing fluid or inability to dry all areas of the vehicle. Systems that include movement, do not adequately account for the differences in vehicle shapes and sizes and can lead to damage or need to stay so far away from the vehicle that they are ineffective. The contacting of the vehicle during washing can drag the dirt across the vehicle and scratch the finish. Hand drying is cumbersome, slow, can scratch the vehicle if the rag is dirty, and can be expensive due to hiring people to perform a repetitive task.

### SUMMARY

The present system and method solve the foregoing problems by utilizing an adaptive, touchless, robotic washing and drying system. It utilizes robotic arms, precisely aligned and delivered water and detergent that is custom adapted in its application for each vehicle washed, and delivers compressed-air-based drying system custom adapted for each vehicle during a fully automated vehicle wash. The robotic arms are directed by an adaptive control unit that delivers precision directional pathways that ensure the water, detergent, and air delivery heads maintain close proximity to the vehicle to enhance washing and drying efficiency. The adaptive control computer uses AI modeling and adjusts the positioning and angle of cleaning heads that are equipped with one or more nozzles to directionally apply fluid to the vehicle over the course of the wash. The adaptive control system utilizes a series of sensors to define the exterior of a vehicle, generate precision pathways that optimize the application of fluid in minimal passes along the vehicle while maintaining full fluid coverage. The pathways are delivered to the robotic arms which then direct the cleaning heads over the vehicle to deliver the cleaning fluid. The adaptive control system maintains a database of pathing information and a series of set, defined pathing rules. This allows the adaptive control system to perpetually learn from its past pathing, adapt and change future pathing to accommodate changed conditions that are presented by each successive vehicle, but still maintain adherence to a desired overall path structure which in turn ensures that the arms will not entangle, seize, distort, or cause an impact.

Further embodiments and structures of the present apparatus and system will be apparent to one of ordinary skill in the art in view of the description and drawings detailed below.

### BRIEF DESCRIPTION OF THE DRAWINGS

FIG. 1 is a front view of typical wash bay configuration.

FIG. 2 is a view of a robotic arm.

FIG. 3 is a perspective view of a nozzle head.

FIG. 4 is a block diagram of the primary components of the compressed air system.

FIG. 5 is a block diagram of the primary components of the liquid application system.

FIG. 6 is a block diagram of the sensor array and robotics systems.

FIG. 7 is a pathway diagram of the initial generic, predefined path showing the first pass applying soap for the washing cycle.

FIG. 8 is a pathway diagram of the initial generic, predefined path showing the second, return pass applying soap for the washing cycle.

FIG. 9 is a pathway diagram of the generic, predefined path showing the first full soap pass.

FIG. 10 is a pathway diagram of the generic, predefined path showing the second full soap pass.

FIG. 11 is a pathway diagram of the generic, predefined path showing a De-bugging pass.

FIG. 12 is a pathway diagram of the generic, predefined path showing the first detergent pass.

FIG. 13 is a pathway diagram of the generic, predefined path showing the second detergent pass.

FIG. 14 is a pathway diagram of the generic, predefined path showing the 3rd detergent pass.

FIG. 15 is a pathway diagram of the generic, predefined path showing the fourth detergent pass.

FIG. 16 is a diagram of the preferred angle of the nozzle head during passes over the top of a vehicle.

FIG. 17 is a diagram of the preferred angle of the nozzle head during passes along the side of a vehicle.

FIG. 18 is a pathway diagram of the generic, predefined path showing the first rinse pass.

FIG. 19 is a pathway diagram of the generic, predefined path showing the second rinse pass.

FIG. 20 is a pathway diagram of the generic, predefined path showing the third rinse pass.

FIG. 21 is a pathway diagram of the generic, predefined path showing the fourth rinse pass.

FIG. 22 is a pathway diagram of the generic, predefined path showing the fifth rinse pass.

FIG. 23 is a pathway diagram of the generic, predefined path showing the sixth rinse pass.

FIG. 24 is a pathway diagram of the generic, predefined path showing the first additive application pass.

FIG. 25 is a pathway diagram of the generic, predefined path showing the second additive application pass.

FIG. 26 is a pathway diagram of the generic, predefined path showing the first spot free pass.

FIG. 27 is a pathway diagram of the generic, predefined path showing the second spot free pass.

FIG. 28 is a pathway diagram of the generic, predefined path showing the first air dry pass.

FIG. 29 is a pathway diagram of the generic, predefined path showing the second air dry pass.

FIG. 30 is a pathway diagram of the generic, predefined path showing the third air dry pass.

FIG. 31 is a pathway diagram of the generic, predefined path showing the fourth air dry pass.

FIG. 32 is a pathway diagram of the bay cleaning process.

FIG. 33 is an overview of a bay.

FIG. 34 is a front-view depiction of the relative locations of positioning sensors in a bay.

FIG. 35 is a top-down depiction of the relative locations of monitoring cameras within the bay.

### DETAILED DESCRIPTION OF EMBODIMENTS

Throughout the specification, wherever practicable, like structures will be identified by like reference numbers. Unless expressly stated otherwise, the term “or” means “either or both” such that “A or B” includes A alone, B alone, and both A and B together. “Approximately” as used herein means rounding to a scientifically significant figure.

In general, the present system comprises a vehicle wash bay chamber with walls, a ceiling and floor having two openings on either end, essentially a tunnel. A vehicle drives in through one end of the bay along a centralized path, stops within the bay, is washed, dried, and then proceeds to drive out of the other end of the bay. While having a bay is not essential, it helps protect the robotic systems from exposure, minimizes over spray into the environment, and helps control the atmosphere and washing conditions to enhance uniformity and reliability in repetitions of the operation of the system by minimizing environmental variables.

A plurality of sensors are positioned within the bay. The sensors detect the presence and shape of a vehicle within the bay. For example, the system may use a plurality of cameras. Positioning cameras at various heights and positions allows for the cameras to capture the entirety of the shape of the vehicle. For example, the cameras may be mounted at the respective ends of each robot arm mounting rail (i.e. the rails that guide the lateral movement of the base of robot arms within the bay). It has been found that positioning 4 stereo cameras at these locations provides comprehensive coverage of the bay. Additionally, one or more sets of photo eye light curtains may be positioned within the bay to ensure that a target car to be washed is positioned within a predefined space within the bay. For example, one set of photo eyes may be positioned at the front of the bay (defining the front-most limit), one set at the back of the bay (defining the backmost limit) and one may be positioned in between may be used to sense the presence of a correctly positioned vehicle. The data from the one or more sensors is supplied to a computer that generates a three-dimensional model of the vehicle within the bay. While a single sensor could be used and moved over the vehicle, such a system would increase the duration of the wash cycle and could result in a poor customer interaction. Such three-dimensional modeling systems are conventional.

Two robotic arms are positioned along tracks within the bay. The tracks allow the robotic arms to move along the length of the vehicle. Each arm is equipped with multiple multiaxial joints separated by support struts to allow the arms to move in all directions within the three-dimensional space of the bay. For example, the arm may include a six-axis servo joint connected to a motorized vehicle that moves along the track. Support struts extend to an “elbow” multi-axis joint, and from the elbow to a “wrist” multi-axis joint that connects to a nozzle head.

The nozzle heads include a plurality of fluid delivery nozzles. One set of nozzles is connected to a series of hoses that deliver water or detergent. A second set of nozzles delivers forced air. These nozzles are arrayed on a head that is attached to the robotic arm.

The control system is a computer (or computer system) that processes the adaptive control scheme utilized by the robotic arms. It stores a set of predefined pathing instructions that are utilized, generally, for each vehicle to be washed. The predefined pathing instructions include a set of baseline paths that are the correspond to the generic paths along which the robotic arms are to move during various portions of the washing cycle (e.g. soaping path, rinsing path, air dry path). These instructions include the range of distance the nozzle heads should be kept from the vehicle. In practice, 6 inches to 18 inches has been found to be optimal. When the pathing allows for less than 6 inches, the precision necessary to maintain that close of a distance slows the operation of the system and requires more passes because the spray from the nozzles is more concentrated at the closer distance. At over 18 inches, the force of the fluid from the nozzles decreases and becomes less effective at cleaning the vehicle.

The rules also include permissible (or restricted) movements of the arms. The arms are designed to work in tandem to clean the entirety of the vehicle. This is generally accomplished by each arm being responsible for cleaning one half of the vehicle. The rules ensure that the arms do not cross each other, or bend in such a way that a portion of the arm enters into the path of the other arm

The washing system is customizable to allow for a menu of washing options. Customers may select the type of wash they require, and the adaptive control system customizes the movement and application of fluid in accordance with the customer's requests. For example, in winter environments, a customer may simply want a quick rinse of water with mild detergent to remove road salt. Another customer with an offroad truck may request multi-pass, heavy wash with more aggressive detergent to remove substantial dirt and mud. Because the movement of the robotic arms and the flow of fluid, and the type of fluid, need not be fixed, the adaptive control system is able to formulate the proper fluid delivered individually and on-demand for each customer according to that customer's vehicle's present state and their menu selection.

The three-dimensional modeling captures the present state of the vehicle. Rather than relying on preset factory specifications, the system captures the vehicle as it exists in the washing bay at the time of the wash. This allows the system to account for alterations to the vehicle from factory defaults (such as the addition of a luggage rack, spoiler, customized trim, lift kits, custom wheel size, etc.) as well as the positioning of the vehicle within the bay (e. g the left/right positioning within the bay, vehicles that are askew within the bay, and the front/back positioning within the bay).

The pathing of the robotic arms in providing the wash impacts the effectiveness of the washing and drying processes. Preferably, each nozzle head is between 14 and 24 inches wide and 6 to 10 inches tall. This balances the need for precision application of fluid with the ability to wash a vehicle in relatively few passes. Shortening the nozzle bar width would require an increase in passes, increasing the overall time it takes to wash the vehicle. Lengthening the width sacrifices the precision, makes it difficult to address the curvatures and angles of the vehicles, and can result in excessive overspray of fluid which is wasted. By keeping the nozzle bar width within the foregoing range, the robotic system is able to wash an entire vehicle in within a time frame of approximately 3.0 to 5.5 minutes (give or take 10 seconds) at an average water consumption of between approximately 15 to 22 gallons of water (give or take half a gallon). The length of time may vary depending on the customer selected wash options (for example, adding a vehicle protection cycle will extend the time, while selecting the minimum wash cycle will keep the rage at its shortest). The water consumption is also dependent on the specific customer selected package, but an average full service wash for a 22 foot-long vehicle is just over 20 gallons. While 22 feet is generally the maximum vehicle length, with average cars being about 16 feet and using 13-14 gallons for a standard wash, the system could be expanded to accommodate larger vehicles.

The control system, which includes a computer processor having inputs, outputs, and a memory, stores a preset, baseline pathway pattern. Through empirical study, it has been found that the utilization of two robotic arms affixed with the aforementioned nozzle heads can effectively perform a touchless wash on a vehicle by progressing along the following general baseline pathway. Beginning at the center of the font bumper, preferably below the font bumper and angled slightly above horizontal, fluid is discharged from the nozzles as the arms rotate the nozzle heads to match the curvature of the vehicle while drawing the nozzle heads back, across the hood, windshield, roof and rear of the vehicle to mirror the starting position, but at the center of the rear bumpers. The nozzle heads are then moved outward by at least the width of the nozzle heads. In some cases the nozzle heads may be tilted slightly outwardly, so as to spray fluid directionally down and toward the passenger and driver sides of the vehicle, respectively, rather than straight down. The heads are drawn forward across the back of the vehicle, roof, windshield, hood, and positioned again by the font bumper, this pattern is repeated for the width of the vehicle before rotating the heads to vertically align with the sides of the vehicle and performing back and forth passes from the top down until the vehicle is covered. The same pattern is repeated by discharging air, instead of water and detergent.

As a further example, a series of pathways and product delivery are utilized. There is a detergent pathing series. Soap is applied from the bottom up, so that a detergent, such as a soap, is first applied where the vehicle is the dirtiest. The detergent passes begin at the front of the vehicle and move around the sides of the vehicle to the back, then back to the front, where the soap pass then proceeds up over the hood, following the edge of the vehicle, to the back of the vehicle again, and finally returning to the front of the car, closer to the center of the vehicle. This generally comprises four total paths for the detergent pathing series, and is generally accomplished at 18 inches from the vehicle surface. In some circumstances, it is necessary to approach the vehicle at a closer distance. Whisker sensors prevent rigid portions of the nozzle head from physically contacting the vehicle, and the control system is used to calculate alternative angles of positioning the nozzle head base on successive projected pathway passes to maximize coverage of the nozzle spray in such circumstances. However, this tends to result in a longer overall time in the wash bay due to the precision necessary to prevent contact with the car.

The rinse pathing series works the opposite direction. The rinse is applied top down, essentially in reverse of the soap pathing and at a closer distance to the vehicle, generally 6 to 8 inches from the vehicle surface. The rinse pathing series generally comprises six high pressure rinse paths.

One or more additive series may also be accomplished. A “spot free” additive may be sprayed on the vehicle. This is generally done in two paths over the top and edge of the vehicle, starting at the front and ending at the front. When additional additive series are performed, it has been found that they can be effectively applied by repeating the same pathings.

Last is the air dry pathing series. The air dry is designed to shear fluid off of the surface of the vehicle. Air dry passes begin at the front and generally use three passes moving progressively outward and downward to blow fluid off of the vehicle.

The precise movements of the robotic arms and nozzle heads is dictated by the adaptive control system though utilization of the 3D model captured prior to wash, processing the 3D model and simulating robotic arm passes over the vehicle according to the general baseline pathways, but adapting the simulated passes (e.g. successive prediction pathways) to refine the general pathways and arrive at a set of target pathways in compliance with the set movement rules for the robotic arms. The arms then execute the target pathway in real-time utilizing the spraying of water, detergent, and air to clean the vehicle.

The prediction pathways follow the same preset baseline pathways but successively make fine adjustments in predicted position of the robotic arms and nozzle heads relative to the three-dimensional model of the vehicle created using the data from the vehicle sensors in the bay. This allows the system to run successive simulations of the predicted paths against the rules for movement of the robotic arms and the three-dimensional model and determine whether there will be any interference or adverse interaction between the robotic arms, nozzle heads, bay, or vehicle while continually refining the predicted pathways to achieve a specific set of target paths that are within the desired range for applying fluid to the vehicle. Once the target paths are determined, the control system can actually control the robotic arms to follow the target paths to wash the vehicle.

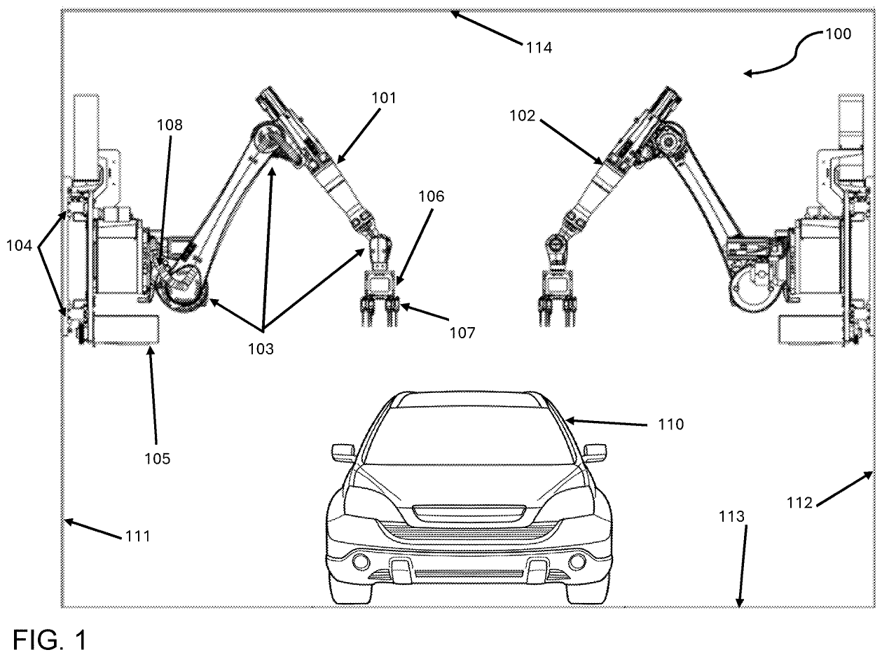

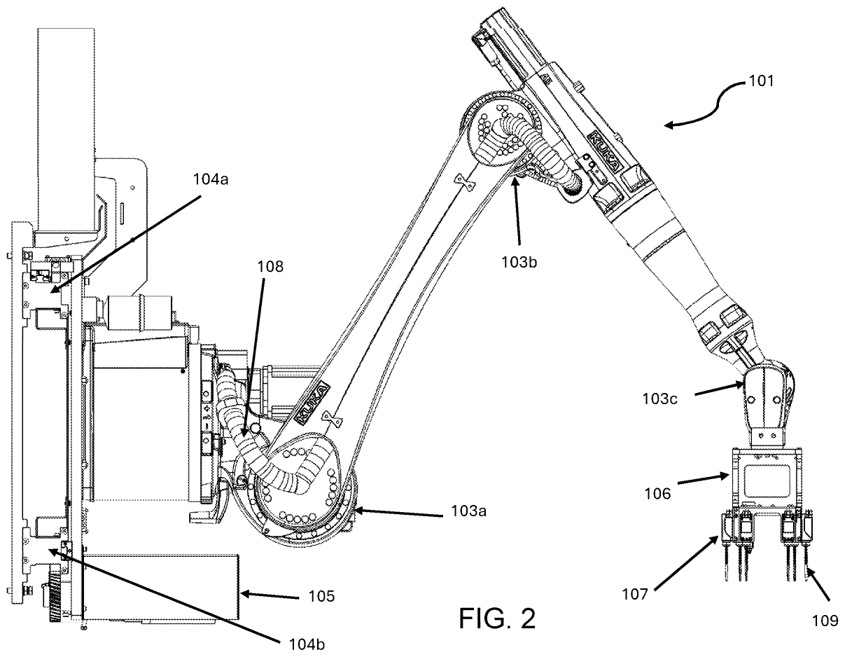

FIG. 1 is an example of a bay 100 with side walls 111, 112, floor 113, and ceiling 114. It includes two robotic arms, 101 and 102 (see also FIG. 2). The arms are provided with multiaxial joints, 103 (e.g. joints 103a, 103b, 103c in FIG. 2). A nozzle head 106 is connected to a distal end of a robotic arm. The proximal end of the arm is connected to mounting system. In FIG. 1, the mounting system is a plurality of horizontally aligned rails 104 (e.g. 104a and 104b in FIG. 2). A motor 105 moves the robotic arms along the rails. The nozzle head includes a plurality of nozzles 107. The nozzle head may also include one or more proximity safety sensors, such as whisker sensors 109. Tubing 108 supplies fluid (e.g. air, detergent, additives, water) to the nozzles of the nozzle head. The robotic arms are controlled by the adaptive control computer system (not shown) to move the arms over a vehicle 110.

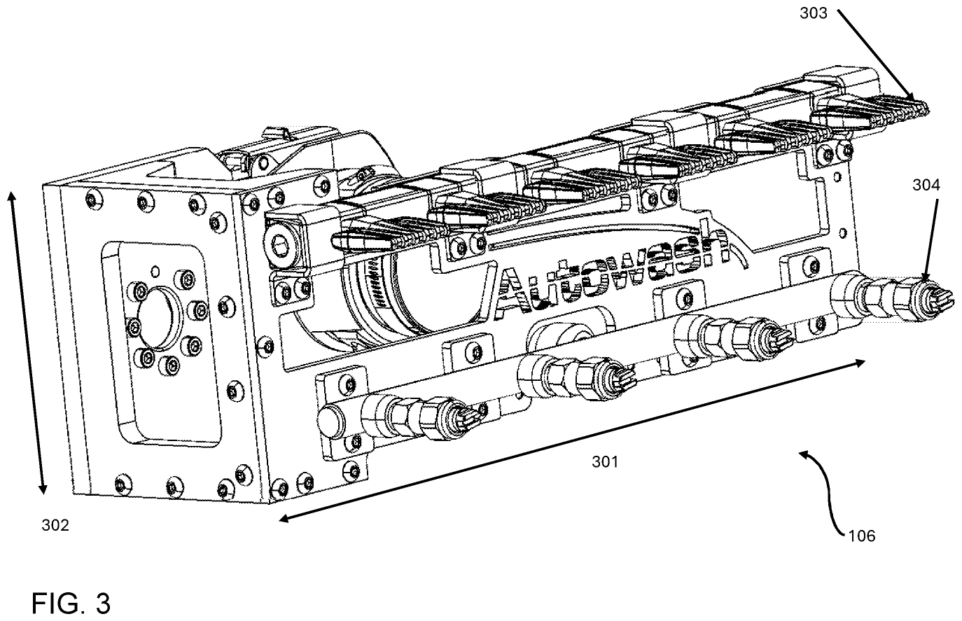

FIG. 3 is a close-up depiction of a nozzle head 106. It has a width 301 and a height 302. In one embodiment the width is 18 inches and the height is 7 inches. For reference herein, when the nozzle head is in the horizontal orientation, the width is generally parallel to the ground. The nozzle head can be rotated about the horizontal axis to angle the nozzles and their resultant spray with respect to the vehicle. The nozzle head may also be rotated to position it in the vertical orientation, such that the width is generally perpendicular to the ground. Again, the head may be rotated in the vertical axis (which is still about the axis of the width) to adjust the angle of incidence of the spray to the vehicle. It should be understood that these orientations are merely for reference in discussing the gross movements of the arms and nozzle heads and are not limiting. The nozzle heads may be moved and rotated in all directions in three-dimensional space, including adjusting their yaw, attitude, pitch, and bank with respect to the vehicle.

The nozzle head 106 includes a plurality of air nozzles 303. The air nozzles are preferably structured as air blades. Rather than forcing streams of air from a cylindrical pipe, the air nozzles are flattened to direct air in the form of a pressurized sheet. This allows the nozzle head to direct forced air across the width of the nozzle head and direct water droplets on the surface of the vehicle in a directional manner, rather than simply scattering them. The control system coordinates the movement of the robotic arms and nozzle head through the cleaning pathways defined by the control system at the beginning of the wash cycle. In some instances, the drying pathways may be altered from the original pathways. This may sometimes occur when the depth of the wash cycle is more comprehensive (for example requires multiple passes to fully wash the vehicle that is heavily soiled) than what would be necessary to merely dry the vehicle. In such instances, prior to drying, the control system may again utilize the 3D scan of the vehicle, run drying simulations in conjunction with the general predefined pathways, and develop a specific set of drying pathways for the vehicle.

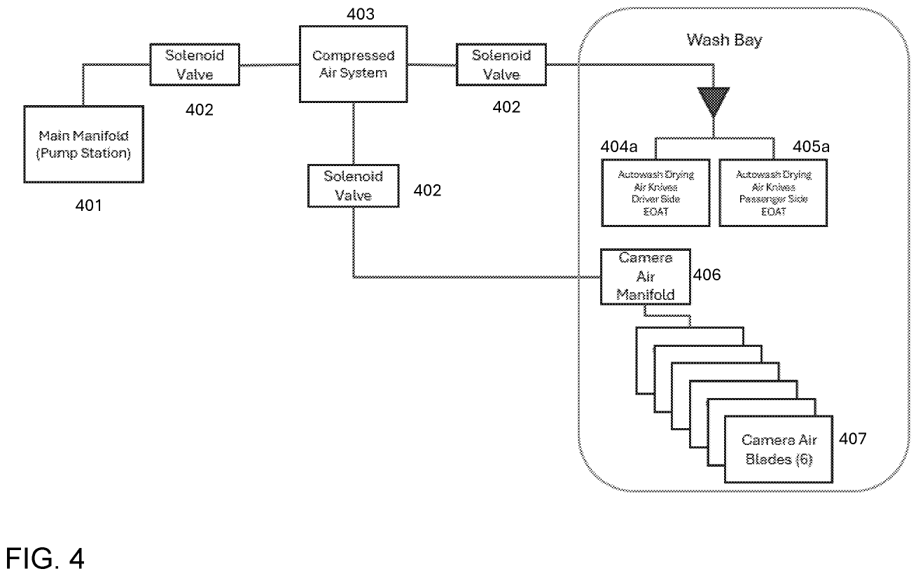

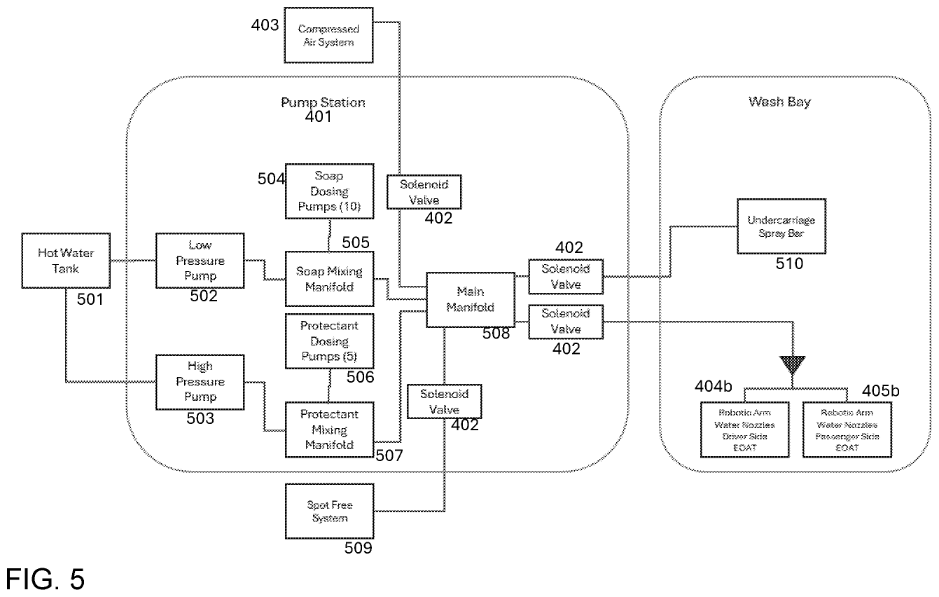

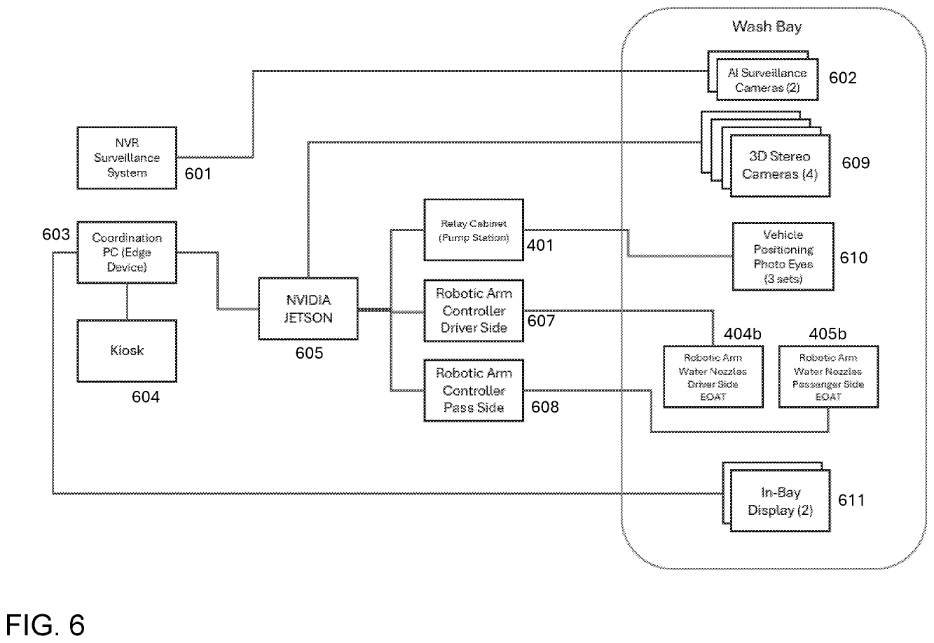

The totality of the system may further be divided into a number of sub systems. With reference to FIGS. 4-6, there is an Air System (FIG. 4), a Fluid (Wash) System (FIG. 5), and an Electronic System (FIG. 6).

The Air System is comprised of a Main Manifold (Pump Station) 401 and Compressed Air System 403. The Pump Station pressurizes the Compressed Air System (e.g. a tank), to enable the air system to provide consistent regulated air pressure. This provides air pressure through tubing connected to each of the air nozzles on the nozzle heads. Actuation of the valves 402 allows for the release of the pressurized air through the nozzles (e.g. the Air Knives 404a (see e.g. FIG. 3, air nozzle 303) on the driver side nozzle head, and the Air Knives 405a on the passenger side nozzle head). The cameras 406 within the bay are also provided with air nozzles 407 adapted to expel air over the camera lenses. For example, among a plurality of cameras, the bay may include 6 cameras positioned throughout the bay. During a wash cycle, mist is generated within the wash bay. If unaddressed, this mist can clog the camera lenses or otherwise affect the reliability of the cameras ability to sense the features of a vehicle with the bay. Air nozzles are positioned proximately to each of the cameras and the valving is actuated to release air in the direction of the lenses to thereby prevent the buildup of water/detergent droplets on the lenses of the cameras (or mineral deposits from water droplets being allowed to evaporate from the surface of the lens). This keeps the sensors clean so that they will reliably sense the contours of vehicles over repeated wash cycles of multiple vehicles.

The Fluid Washing System is described in FIG. 5. A water tank (or water supply) 501 houses water to be used during the washing cycle. One or more pumping stations 401 may be used to pump water from the tank to a mixing manifold where the water and a detergent or other additive is mixed with the water. As shown in FIG. 5, a low pressure pump 502 pumps fluid to the soap mixing manifold 505 while one or more dosing pumps 504 pump soap to the manifold. Different types of customizable washes may utilize alternative soap formulations and ratios depending on the wash selected. For example, some formulations are geared towards salt removal, others focus on oil or other road soil, other focus on mud and dirt, etc. Before the wash, a customer will select the desired type of wash, and during the wash cycle, the control system doses a corresponding soap (or soap mixture) at a preset ratio over the course of the wash cycle. Additionally, another pump, such as High Pressure Pump 503 pumps water to another manifold (Protectant Mixing Manifold 507) that mixes an additional applicant, such as a protectant provided by dosing pumps 506, to be applied during the wash cycle. Additional applicants may be a wax product, rust inhibitor, polish, or other product. The control system doses the appropriate ratio of applicant based on preset ratios, and applies them on demand according to a customer's selected wash type. The mixed applicant is pumped through a main manifold 508 that distributes the product to the robot arms and to the nozzle heads 404b, 405b which sprays the fluid according to the signals of the control system during the washing cycle. In one embodiment, an additional nozzle array, such as a bar 510 having a plurality of nozzles, is positioned beneath the vehicle and adapted to spray fluid through the nozzles to clean the undercarriage of the vehicle.

FIG. 6 details the Electronic Control system. It includes the NVR Surveillance System to detect anomalies. The NVR 601 is a surveillance video camera recording system. It utilizes cameras 602 to monitor the activity in the bay and its signal is relayed to a computer which utilizes software to analyze the incoming video feed for unexpected events. This may include a sudden change in the shape of the vehicle (for example the water pressure dislodges a panel that alters the profile of the vehicle, or a customer inadvertently opens a door) or an unexpected foreign object enters the bay (such as a person walking into the wash bay). In the event that an anomaly is detected, the computer system is configured to issue an alarm, shut down the operation of the arms, or take another precautionary measure.

A computer 603, such as a PC, works with a robotics processor 605, such as an NVIDA JETSON which processes the sensor data from, for example, the cameras 609 that sense the shape of a vehicle in the bay. It also communicates with drivers for the two robotic arms 607, 608 to control the operation of the arms in accordance with the selected wash and the pathing identified by the adaptive control program. The positioning photo eyes 610 are a set of light curtain sensors that assist in determining whether a vehicle is properly positioned within the bay. The computer also communicates with the Pump Station 401 to control the operation of the pumps and valves.

A user kiosk 604 (e.g. user input station, such as a display, keyboard, mouse, touchscreen, etc.) is connected to the computer to allow for a technician to input commands to the computer. Another in-bay display 611 may be used to provide information to a customer. The display could be a touch screen to allow the customer to select a desired wash. Alternately one or more in-bay displays may provide informational displays, such as the progress of the wash.

As shown in FIG. 2, each nozzle head 106 may be equipped with one or more whisker sensors 109. The whisker sensors extend from the nozzle head and are adapted to sense physical impact at close range to the nozzle head. These operate as an additional safety measure. As the nozzle heads move over the vehicle, the whisker sensors will send a signal to the computer if they physically contact a structure. This might be a structure that was not sufficiently captured by the 3D scan and modeling, or may result from a misjudgment that allows the robotic arm to get too close to the vehicle. Tripping the whisker sensor will cause the system to issue an alarm, shut down, or take another precautionary measure.

As discussed above, curtain sensor arrays are used to detect the position of the vehicle in the bay. If a car pulls too far forward, a “backup eye” curtain sensor trips, signaling the car to reverse and back up to reposition itself in the bay. This ensures there is adequate clearance for the arms to reach the front of the vehicle and properly perform the washing cycle.

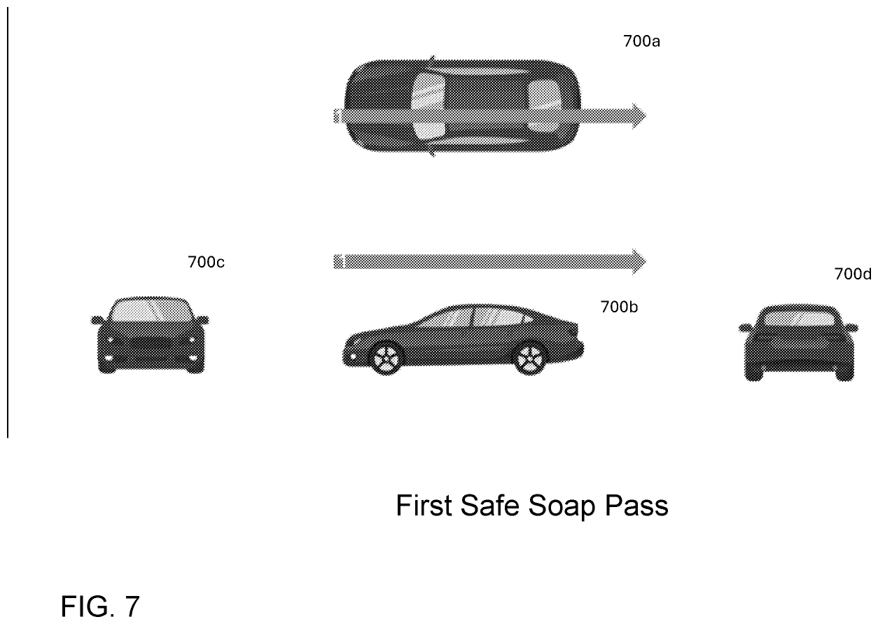

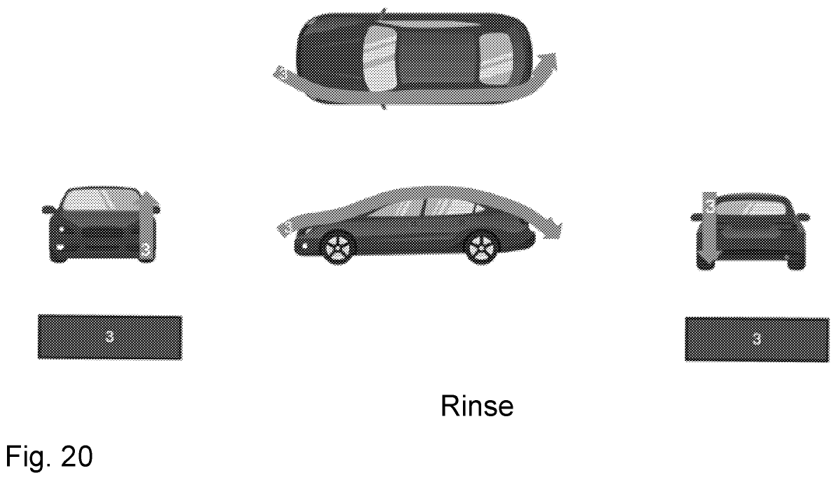

As discussed, the control system utilizes a stored generic pathway for the robotic arms as a starting point, processes a three-dimensional model of the vehicle utilizing and adaptive AI-based computer program to run simulations and develop the optimal pathway for the particular vehicle, and then proceeds with the wash. With reference to FIGS. 7-15 and 18-31, the general pathway is shown and the general operation of the system (including the general stored pathway that the AI control system refines) will be discussed. It should be understood that the pathing will be discussed with respect to a single robotic arm and nozzle head, which, in operation, would be mirrored simultaneously by the second robotic arm and nozzle head, which is responsible for the other half of the vehicle. The minimal effective wash cycle requires at least one soap pass, one rinse pass, one spot free pass, and one dryer pass. It has been found that eliminating one or more of those steps results in an inadequate cleansing of the car, such as by leaving dirt residue or hard water spots.

The control system operates and directs the movement of the robotic arms in conjunction with the sub-systems to deliver water, detergent, additional applicants, and air. FIG. 7 shows four views (top, 700a, side, 700b, front, 700c, rear, 700d) of a single vehicle 700 parked in the washing bay.

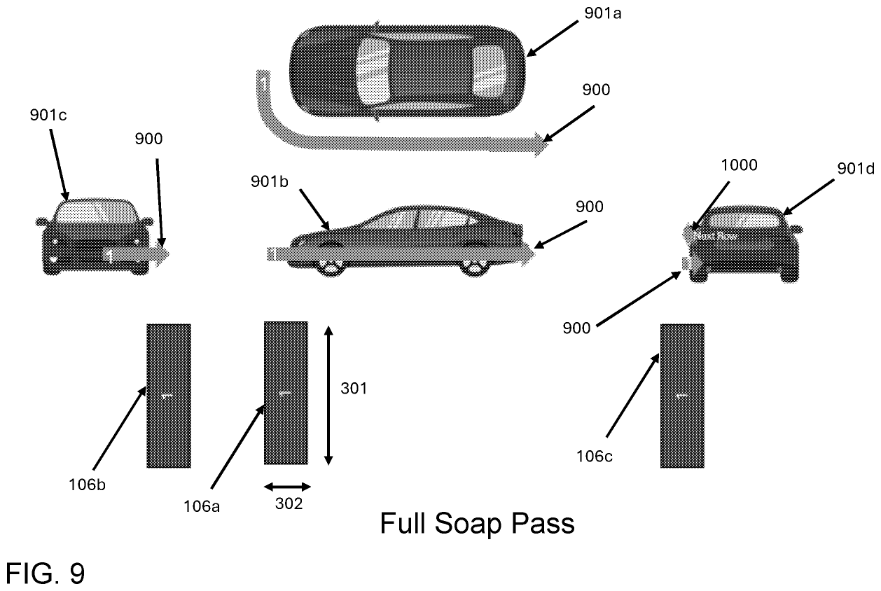

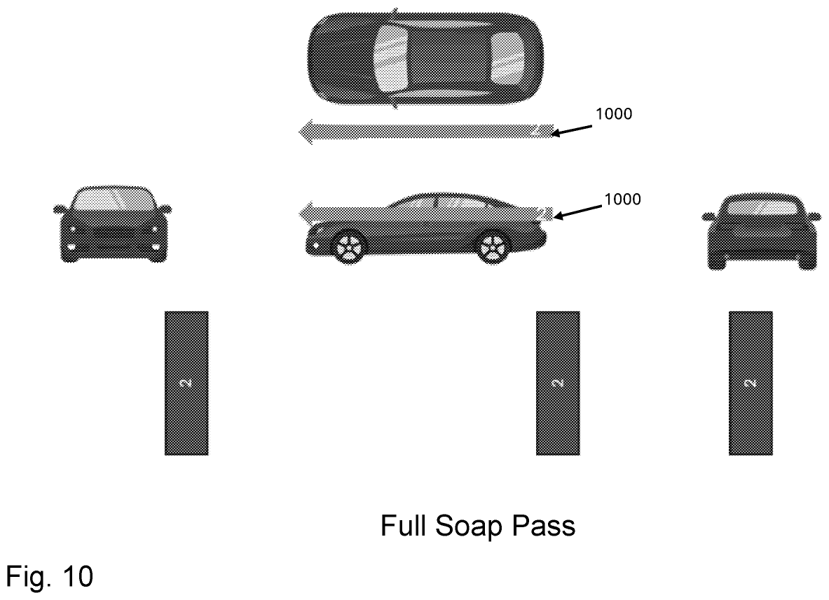

FIGS. 7-15 and 18-31 show the various generic pathways that the AI control system refines for each vehicle along with the orientations of the nozzle heads. All of the figures can be understood in the context of FIG. 9. Referring to FIG. 9, a vehicle 901 is depicted in four orientations, 901a (top down), 901b (driver side view), 901c (front), 901d (rear). All the pathway figures show the same vehicle in those orientations which correspond to views of a vehicle in a bay. The relative position of a nozzle head 106a/b/c/ is also shown. Looking at the front view 901 c, the nozzle head 106b is oriented vertically. It is numbered “1” as it corresponds to the 900 pathway “1”. 106b is the same nozzle head, again moving along the same 900 pathway “1” with the width 302 in the vertical direction. 106c is the same nozzle head, still moving along the same 900 pathway “1” in the same orientation. The nozzle head then moves to the “next Row” 1000, which is depicted as the 1000 pathway “2” in FIG. 10.

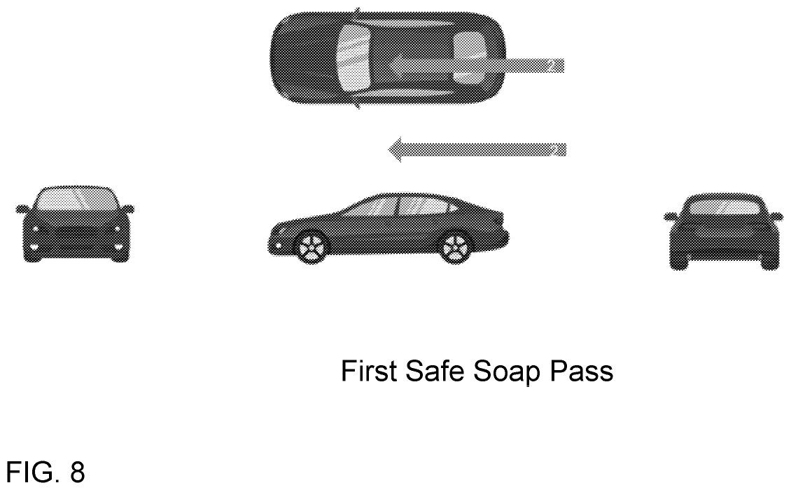

Once the vehicle is parked in the bay, the arm performs a first pass over the top of the entire vehicle. In FIG. 7-8 the first “safe soap” pass is performed where any suitable detergent may be applied. The pass is performed with the nozzle head positioned with its width substantially parallel to the ground and well away from the top of the vehicle, generally two feet or more, or such that the arm progresses at its highest possible position within the bay for taller vehicles. The pass is performed at a low speed and to ensure that there are no obstructions that could interfere with the arm during the remainder of the washing cycle. On the first pass, a low pressure application of water/soap may be sprayed over the vehicle as a pre-soak. In FIG. 8, the arm returns to the front, again at a high distance, slow pace, and may provide a low pressure application of water/soap.

After performing the first back and forth pass, the system performs a high definition scan of the vehicle. The 4 stereo cameras positioned around about the bay capture images of the vehicle and send them to the computer (such as the NVIDIA GPU) for processing. The software compiles and builds the 3D model, then calculates the precise pathways for the rest of the wash sequence based on the predefined general pathways discussed herein. The AI program runs repeated simulations of the preset washing pathways to check the movements of the arms, confirming the arms will not collide or tangle, that the nozzle heads will stay 18 inches (plus or minus two inches) away from the vehicle during four low pressure detergent passes, and stay 8 inches (plus or minus two inches) away from the vehicle at times during six rinse and three air dry passes (the forgoing passes being varied by the AI controller from the baseline set of predefined paths; customers may also select varied pass parameters, such as longer dwell time for the soap, multiple soap/rinse cycles, or slower applications, however the pathing is always determined by the AI based on the predefined general pathways described).

In FIGS. 9-10, a full application of water/soap is applied to the side of the vehicle. The arm moves the nozzle hear across the front, down the side and across the back at a distance of approximately 18 inches. The heads are positioned with the widths oriented generally vertical to the ground. It was found that applying the water/soap at low pressure (approximately 500 psi at the nozzle exit) at an arm speed of about 0.5 m/s provided the most efficient to effective washing ratio. In FIG. 10, the height of the nozzle is adjusted and the arm progresses back to the front of the vehicle applying the low pressure, 0.5 m/s spray of water/soap at about 18 inch distance from the vehicle.

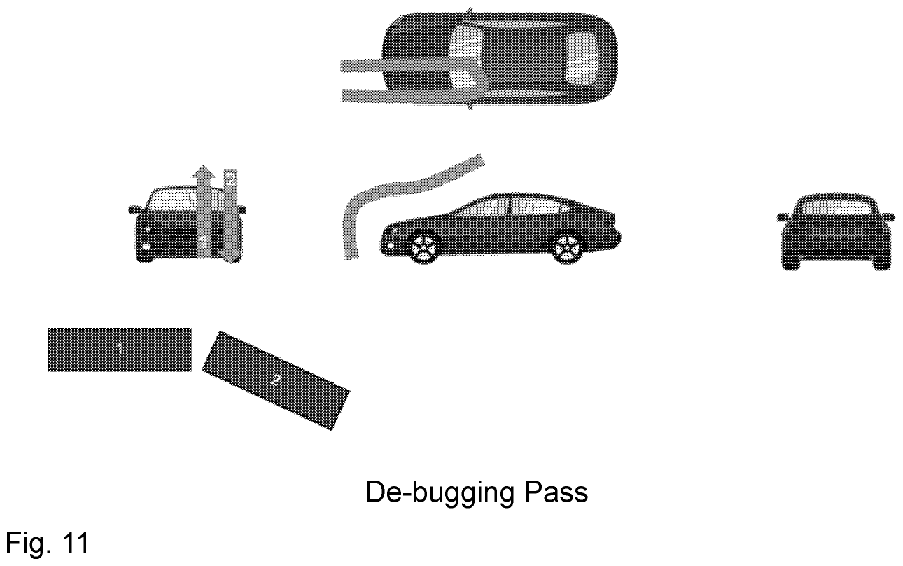

The front of the vehicle often is the most soiled. This area is prone to insect residue and road dirt being kicked up from other vehicles in traffic. In FIG. 11, the system performs an optional additional “de-bugging” pass along path 1 first going up and over the hood, then curving around the top of the windshield before returning along path 2. The de-bugging application utilizes a commercially available solvent formulated to assist specifically in the removal of dead insect remnants, for example Rain-X® bug remover fluid. On the second path, the nozzle head is angled inward toward the center of the vehicle, which ensures that the water/soap mixture is directed at the vehicle, rather than having the nozzle head overhang the outside of the vehicle and simply spray onto the ground. As this is a second pass, it may be accomplished between 18 and 24 inches from the vehicle at low pressure and a speed of 1.0 m/s.

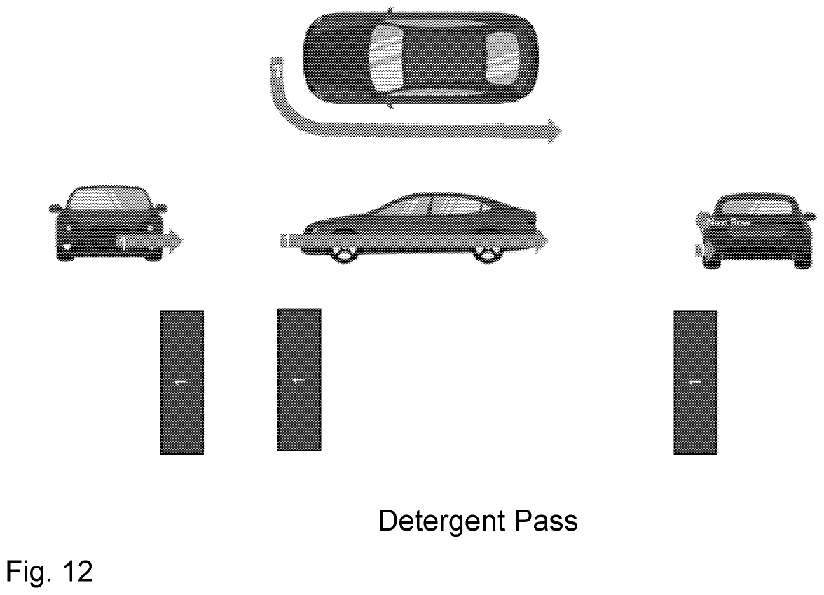

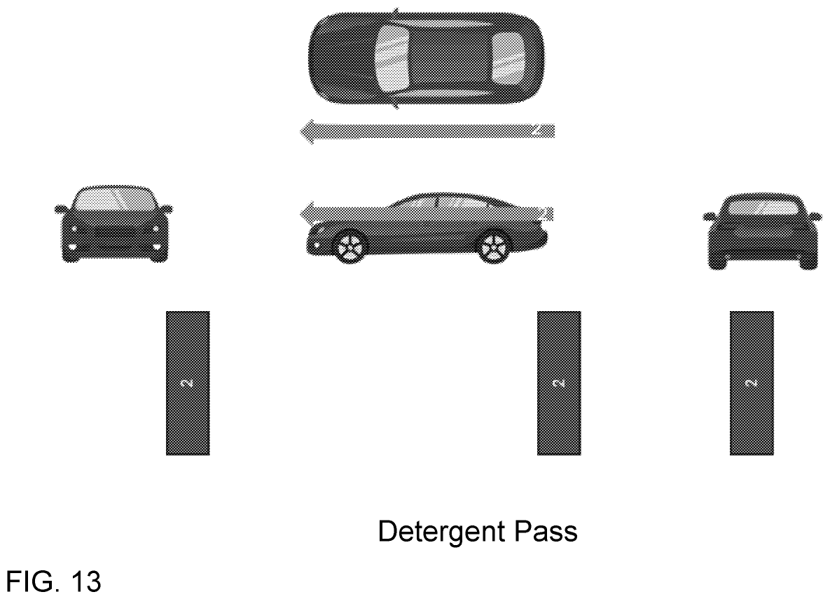

In FIGS. 12-15, a second detergent mix is applied at low pressure, approximately 18 inches from the vehicle and at a speed of 0.5 m/s. It should be understood that this is referred to as a detergent pass simply for ease of reference herein, and not as a limitation on the nature of this or any other pass. In FIG. 12, the pass begins at the bottom of the vehicle, sweeps around the front and down the side, before spraying the back and moving vertically up the vehicle in preparation for the return. FIG. 13 shows the return. On both the first path 1 and return path 2, the nozzle head is held with the width vertical to the vehicle.

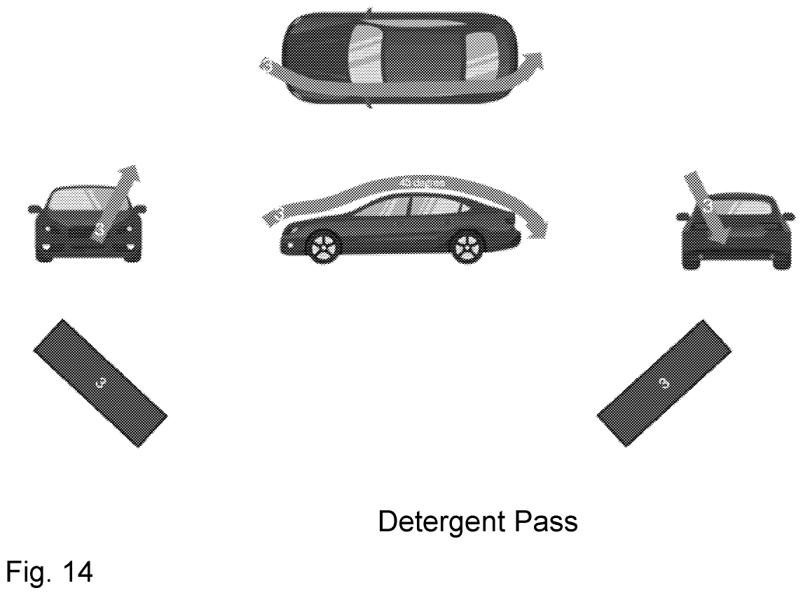

The system proceeds to FIG. 14 and washing the hood and top of the vehicle. The arm progresses along a curved path 3 that matches the shape of the vehicle. The nozzle heads are angled, such as at 45 degrees to the vehicle so that the detergent mix is directed inward at the center of the vehicle rather than straight down. The FIG. 14 pass is performed at approximately 18 inches, at low pressure and 0.5 m/s

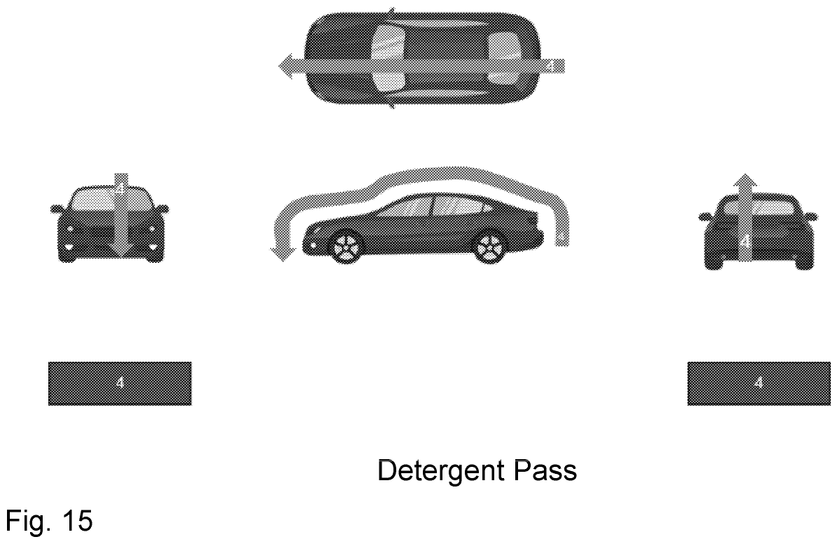

The arm returns in FIG. 15 along path 4. The nozzle heads are flattened as they are passing over the central portion of the vehicle, and thus the flattened orientation provides maximum coverage. The FIG. 15 pass is performed at approximately 18 inches, at low pressure and 0.5 m/s.

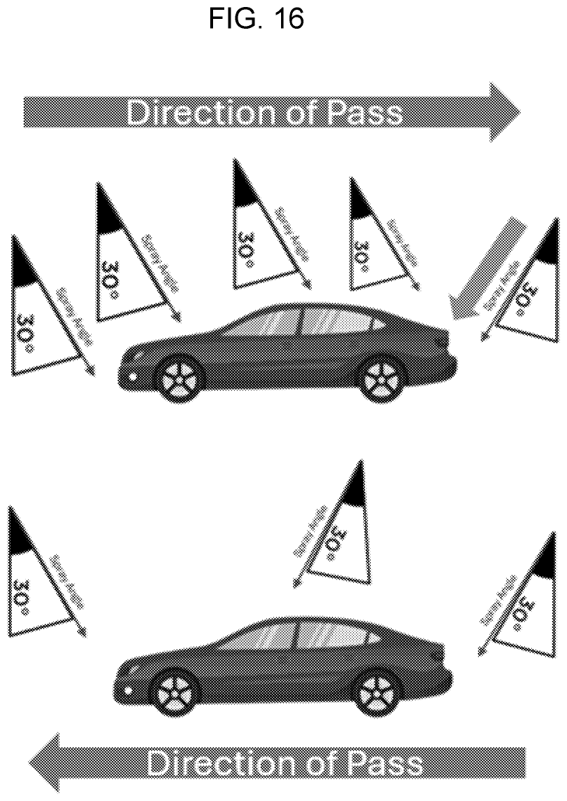

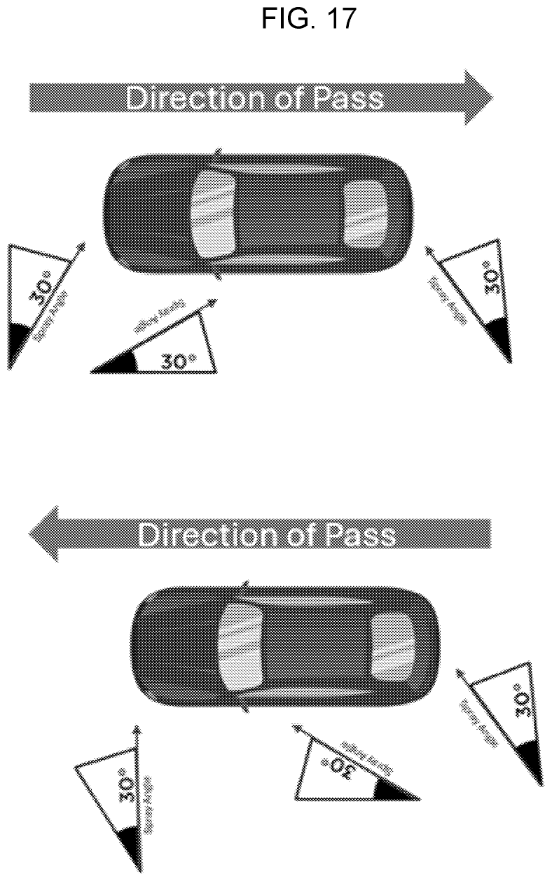

Preferably, during each pass, the nozzle heads are oriented at a 30-degree forward angle to surface of the vehicle. That is, the nozzle head is rotated toward the direction of travel of the robotic arm so that the fluid being ejected from the nozzle head is angled 30-degrees and contacts the surface of the vehicle in front of the nozzle head. FIGS. 16 and 17 show examples, generally depicting the angle of the nozzle head (not shown) as the robotic arm (not shown) moves in the indicated direction. Because the vehicles are formed of a multitude of shapes, the exact angle will vary, but the AI control system, in conducting its simulations, is designed to attempt to utilize the 30-degree angle as the target orientation over the majority of the vehicle. Essentially, the AI system attempts to ensure the fluid is sprayed at the 30-degree angle whenever possible. For example, as the nozzle reaches the rear of the vehicle, the robotic arm will start moving downward, so the nozzle is rotated to adjust for the new direction. Overall, this improves the coverage of the nozzle spray, enhances the cleaning function of the spray and air drying, and maximizes the efficiency of the application of water and air during the process to allow the system to operate with minimal water waste.

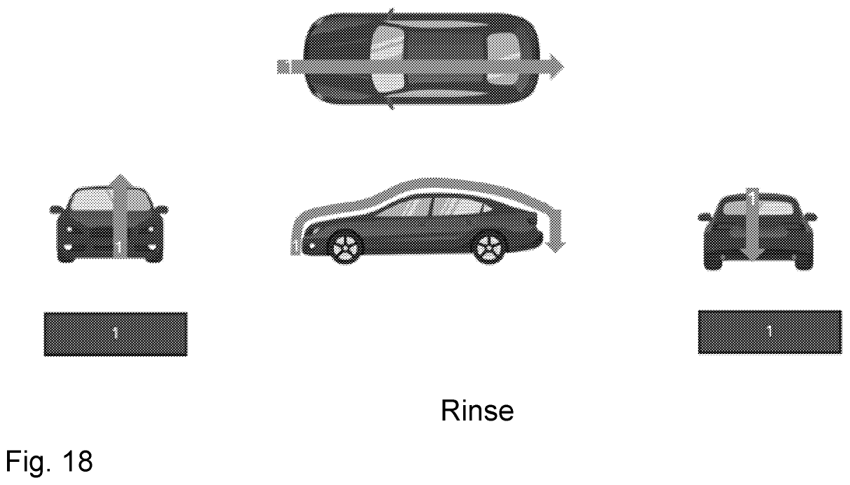

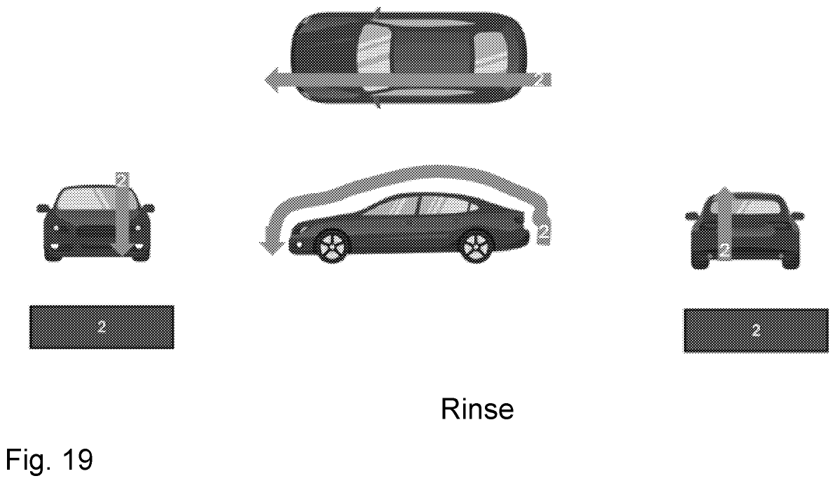

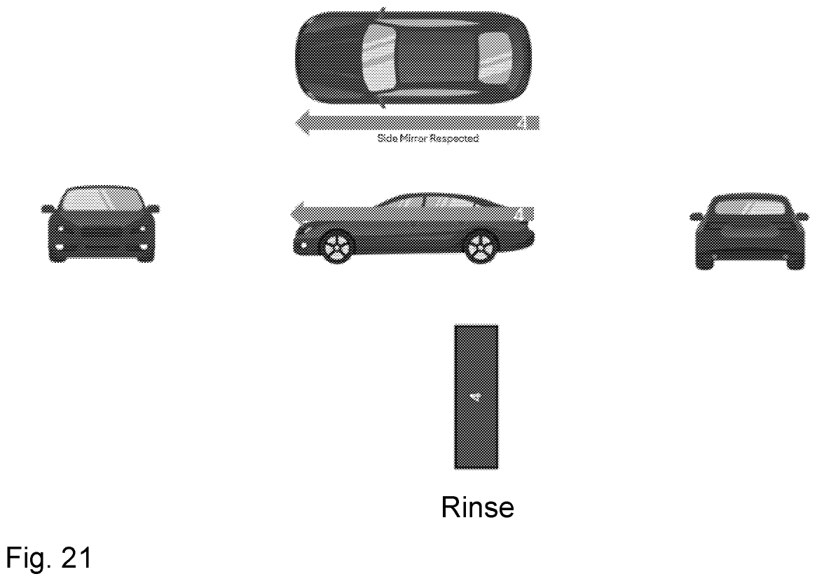

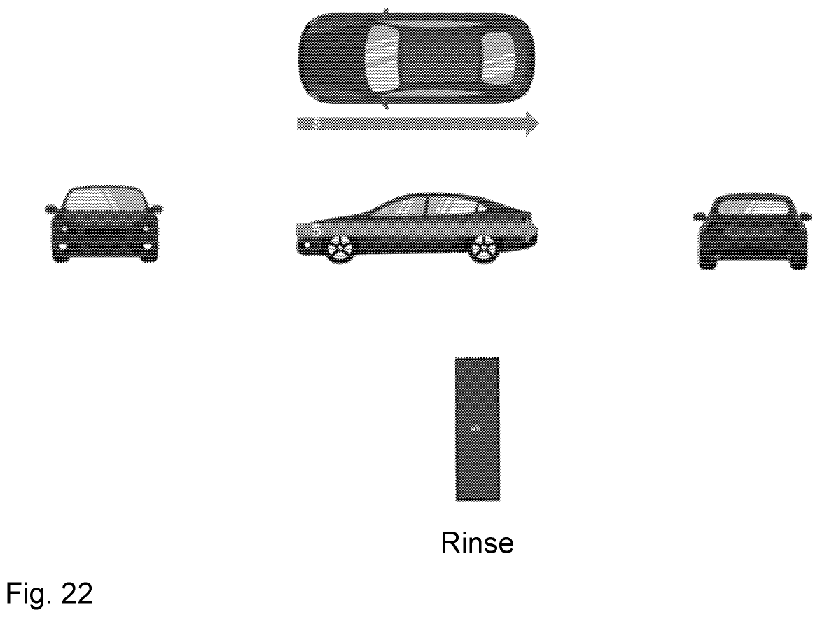

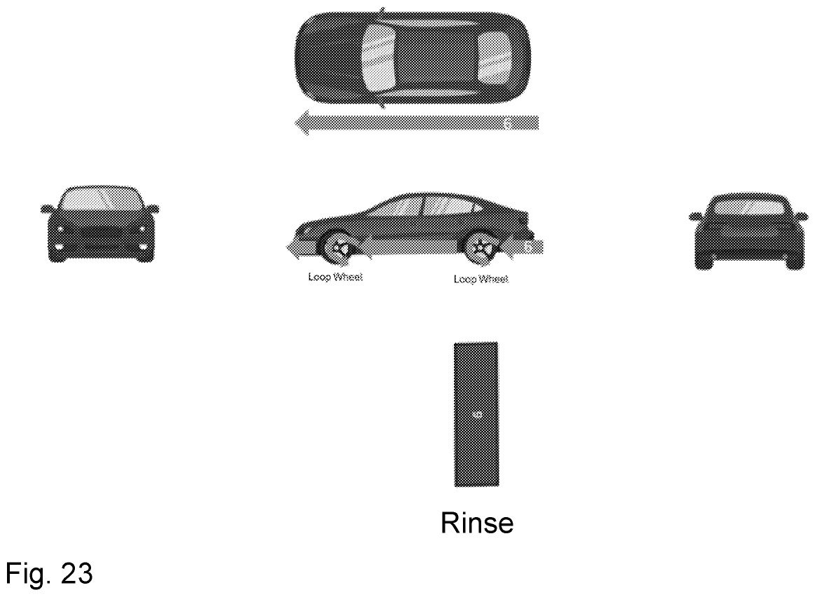

At FIGS. 18-23, the rinse portion of the washing cycle takes place. Beginning in FIG. 18, the nozzle head is positioned approximately 8 inches (plus or minus 2 inches) from the vehicle. Water, or a water rinse aid mix, is sprayed at high pressure (approximately 1000 psi at the nozzle exit) while the arm moves the head at about 1.0 m/s along pathway 1. The first pathway traverses the center portion of the vehicle. The return path 2 is shown in FIG. 19. The nozzle head is moved away from center. Usually, this return path will overlap with the first pass and provide its spray according to the same conditions. At FIG. 21 The nozzle head is then moved to the edge of the vehicle and traverses front to back along path 3, again according to the same conditions. The Nozzle head is rotated so the width is vertical with the ground and the arm brings it from back to front along the side of the vehicle according to the same, approximately 8 inch distance, high pressure, and 1.0 m/s speed. The arm reverses direction at FIG. 22 and proceeds front to back along the side of the vehicle, overlapping with the path of FIG. 21 and providing spray at the same conditions. FIG. 23 shows the final rinse pass. Proceeding along the same spray conditions, the arm moves the nozzle head along path 6 at the base of the vehicle. At each wheel the arm circles the wheel at least once such that the nozzle head sprays the full 360 degree circle of the wheel.

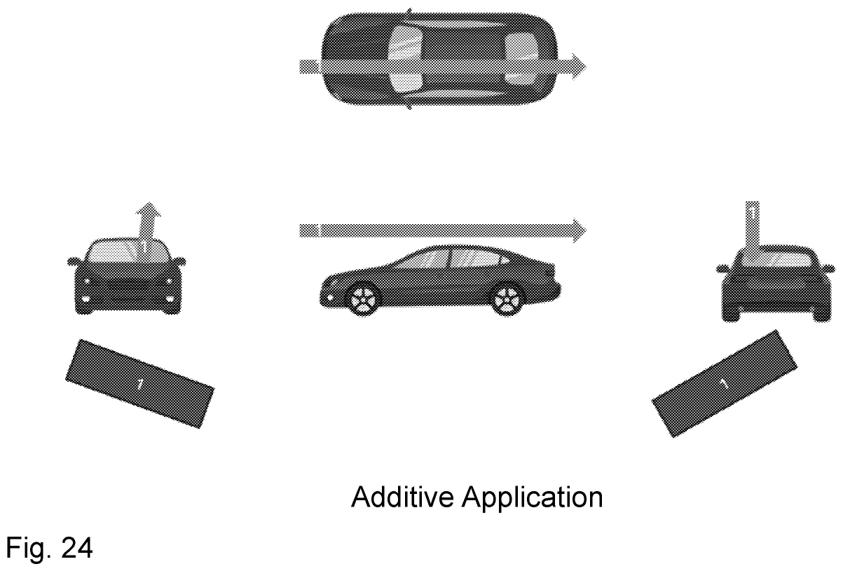

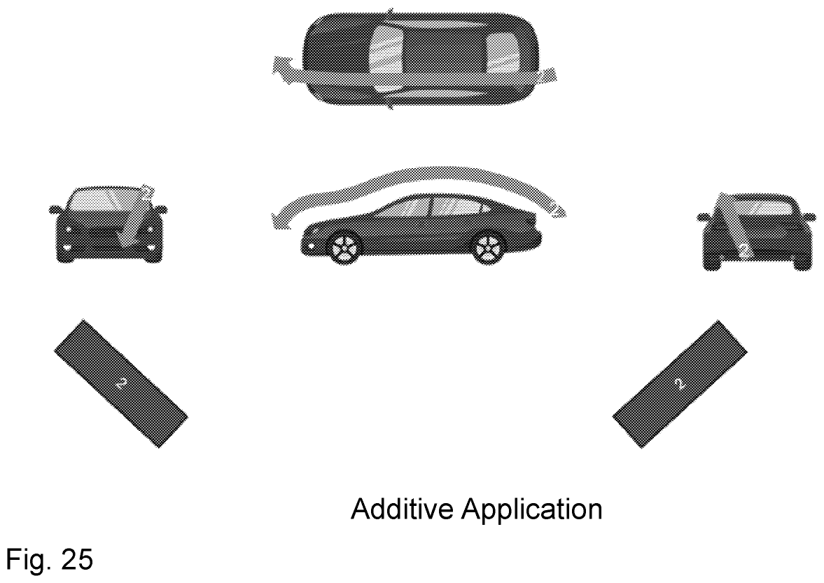

After rinsing the vehicle, additional applications of product may occur. For example, customer may want an application of Grafoam® to add additional protection to the vehicle's finish. If selected the system may proceed to FIGS. 24-25. The additive application of additional protectants generally requires only general spray to coat the vehicle once. The arm angles the nozzle head to provide wider coverage and makes pass 1 at a distance of approximately 24 inches, with low pressure, and a speed of 1.0 m/s. At FIG. 25 the return path proceeds along the top corner of the vehicle with the nozzle heads angled with their widths approximately 45 degrees to the ground. The pass 2 is made according to the same spray conditions as pass 1. At such a distance and angle, a single pass along path 2 is generally sufficient to coat the top corner and side of the vehicle.

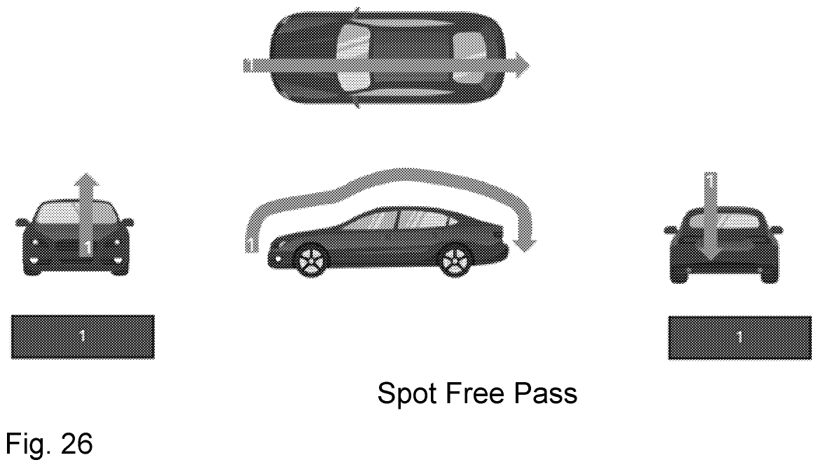

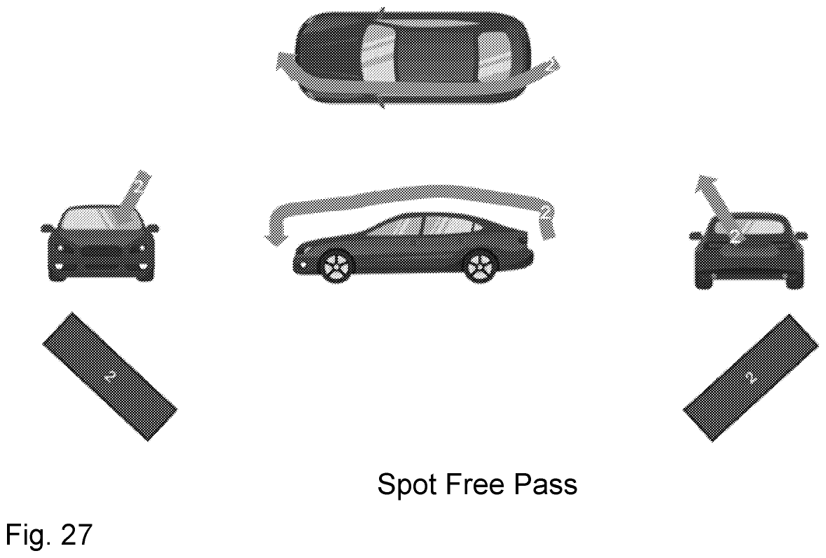

To ensure a “spot free” finish, a step of spraying the vehicle with osmotic water may be used as shown in FIGS. 26-27. In FIG. 26, the nozzle head is positioned approximately 24 inches from the vehicle, and sprays osmotic water at low pressure as the arm moves the nozzle head along the center of the vehicle at path 1 with a speed of 0.5 m/s to 1.0 m/s. At FIG. 27 the arm returns with the same spray conditions, passing along the top corner of the vehicle. The nozzle heads may be angled similarly to the 45 degree positioning discussed with respect to FIG. 25.

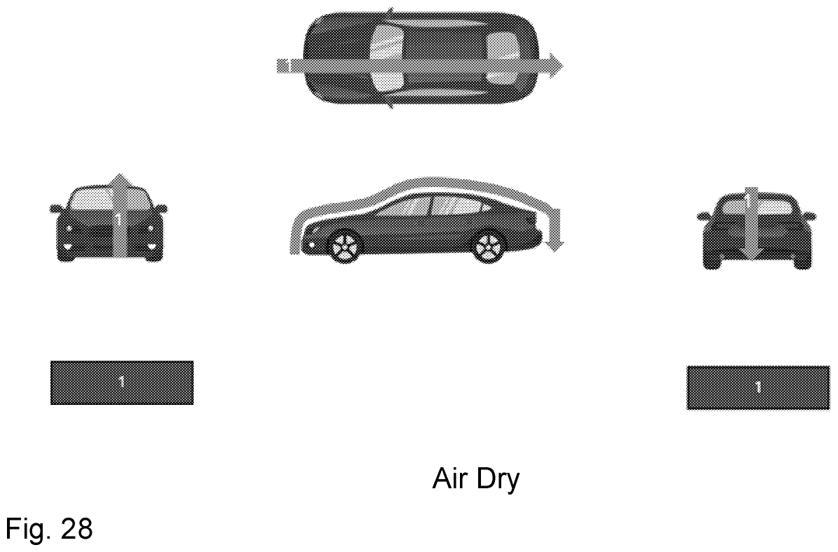

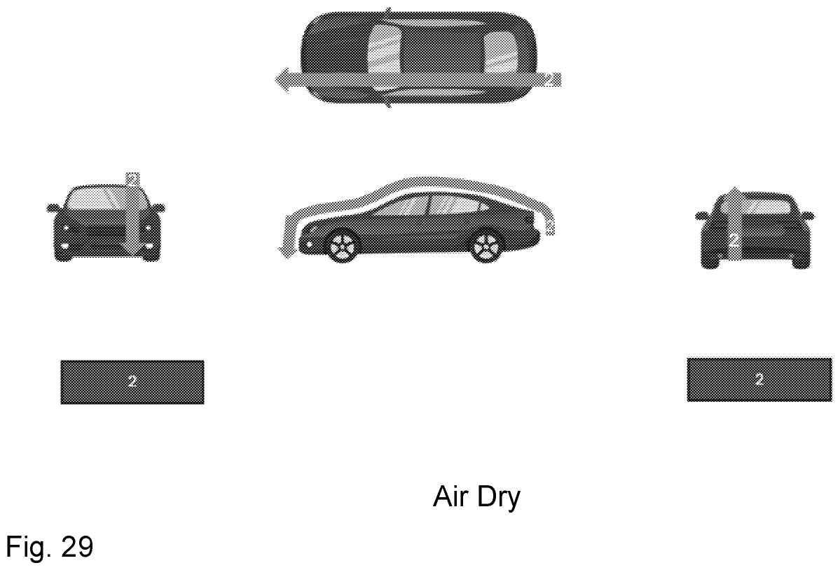

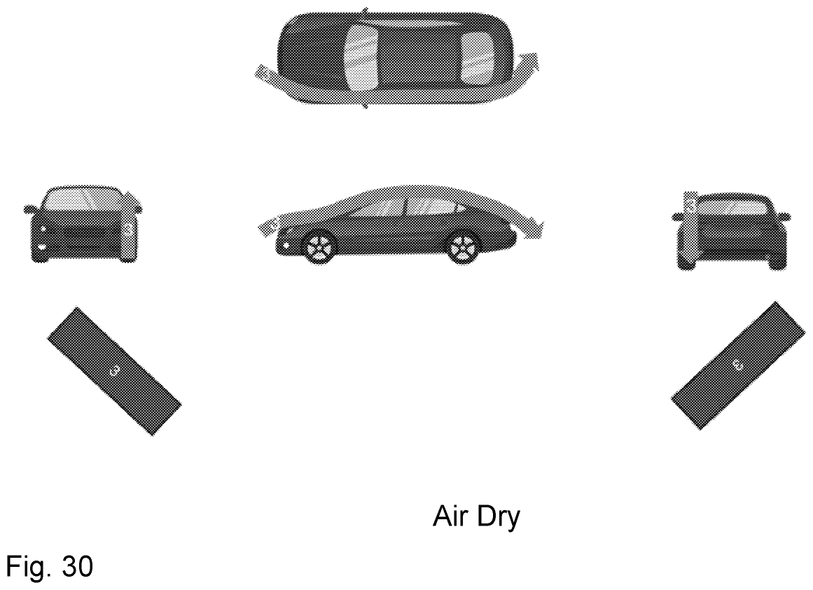

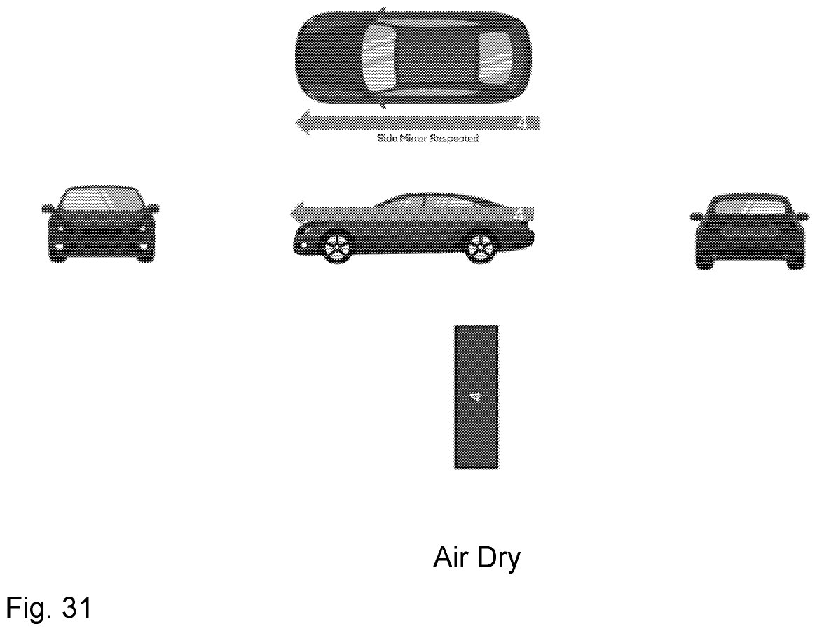

At FIGS. 28-31, the drying process takes place. The valving of the system switches to close the liquid nozzles and open the air blade nozzles. While customers may select alternative parameters (particularly in the speed of arm movement), the default drying parameters, FIG. 28, provide that the nozzle head is positioned horizontally to the vehicle approximately 8 inches from the surface, and proceeding at 0.5 m/s the arm moves the nozzle head through path 1 over the center of the vehicle. The arm reverses at FIG. 29, moves laterally toward the outside edge of the vehicle and returns to the front utilizing the same air spray conditions. At FIG. 30, the nozzle head is angled to approximately 45 degrees and the arm proceeds along path 3 according to the same air spray conditions. The sides of the vehicle may then be sprayed with the air blades if necessary (for smaller vehicles this may not be required). In FIG. 31, optionally, the arm brings the air blade nozzle head across the side of the vehicle along path 4. This step may not be necessary for smaller vehicles. The nozzle head may be vertical or slightly angled to blow air downward. The nozzle head is approximately 8 inches from the surface, and proceeding at 0.5 m/s the arm moves the nozzle head through path 4. In some cases, one or more of any of the foregoing passes may be repeated.

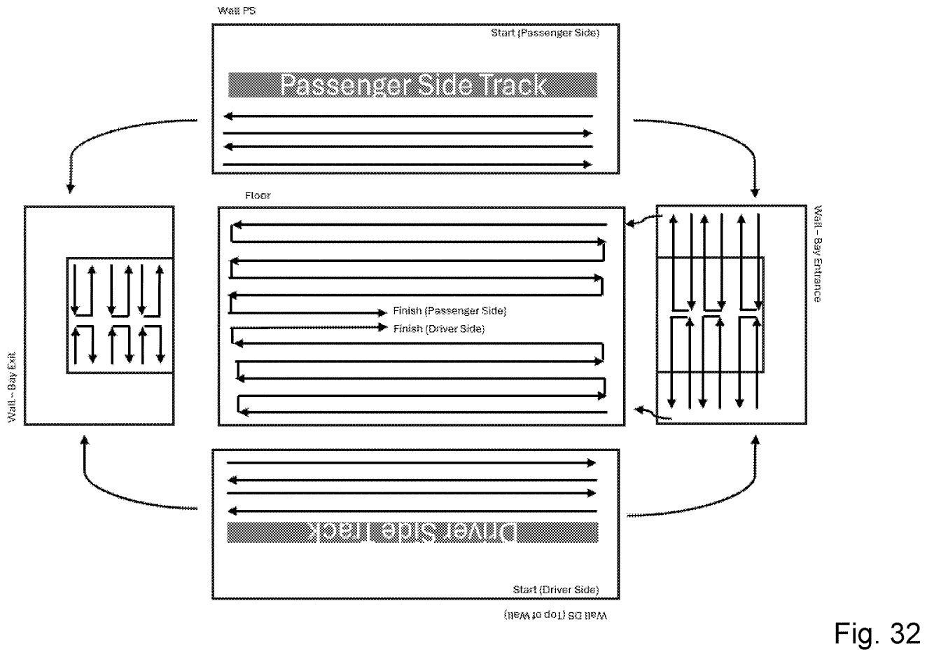

The robotic arms are then moved out of the path of the vehicle and the vehicle is permitted to exit the bay. Once the bay is empty, the control system performed an automated cleaning sweep of the bay along a preset pathway. This is typically done at the end of a full day (rather than after every wash) but can be completed any time the bay becomes overly soiled. In FIG. 32, while the nozzle heads spray water, the robotic arms move the nozzle heads along serpentine paths of the bay front, bay back, passenger side wall, driver side wall and then the floor, moving from the exterior to the interior. The center portion of the bay is provided with a drain down the center that collects the soiled water. The nozzle heads may be positioned approximately 18 inches from the surfaces. On the vertical surfaces, the nozzle heads are angled 30 degrees downward while the width is positioned in the vertical orientation. This provides approximately 30 inches of useful spray coverage. The serpentine paths are programmed such that the spray has 50% overlap. The water is sprayed at high pressure while the arms move at approximately 1.5 m/s.

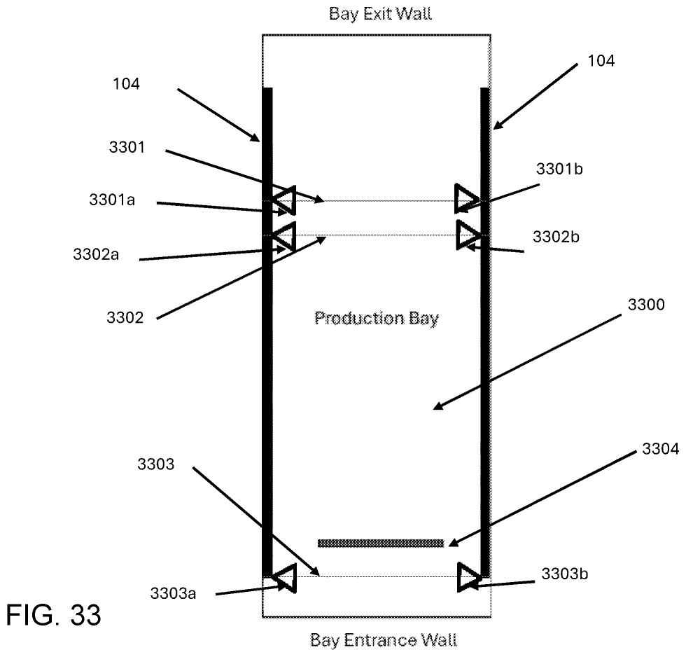

FIG. 33 is a general depiction of a production bay depicting the curtain sensor locations. The bay 3300 has rails 104 for mounting the robotic arms (not shown). A backup eye curtain sensor array, 3301a, 3301b, is positioned toward the bay exit wall, about 2.5-3.5 meters from the end of the robotic arm rail, to project sensor beam 3301 across the bay. A “vehicle present” curtain sensor array, 3302a, 3302 b, is positioned further inward toward the center of the bay, about 3.5-4.5 meters from the end of the robotic arm rail to project sensor beam 3302. This sensor array confirms that a vehicle is properly within the operation area of the bay. A “move forward” curtain sensor array 3303a, 3303b, is positioned near the entrance of the bay, about 9.5-10.5 meters from the end of the robotic arm rail, to project beam 3303. When this sensor is triggered it indicates the vehicle must move forward further into the bay before the wash can start. Undercarriage wash bar 3304 is positioned at the floor of the bay to spray the undercarriage as the vehicle is positioned over the bar.

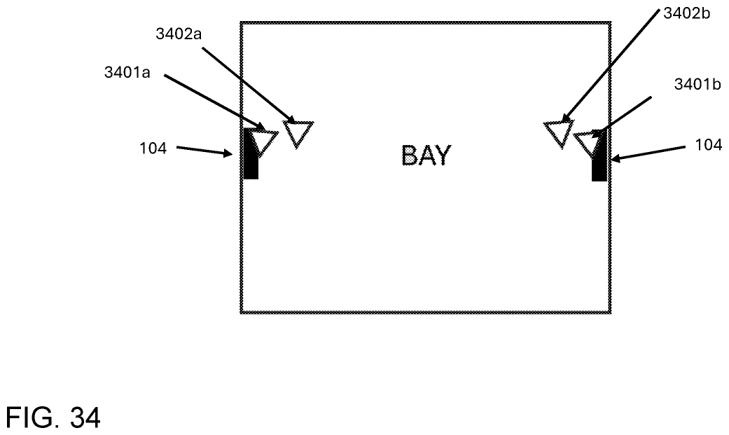

FIG. 34 is a simplified view into the entrance of a bay and camera positions. The three-dimensional modeling cameras 3401a, 3401b are mounted to the ends of the robotic arm rails 104. Utilizing tracks that are mounted about 6.5 feet from the ground to the centerline between the two tracks has been found to provide a good operational range for the robotic arms. Additional surveillance cameras 3402a, 3402b, are mounted within the bay to monitor for any anomalies entering the bay, such as a person or object that could pose a risk to the wash, vehicle, or the anomaly itself. Given the maximum size of vehicles, mounting the surveillance cameras at about 92 inches from the ground provides useful coverage of the bay.

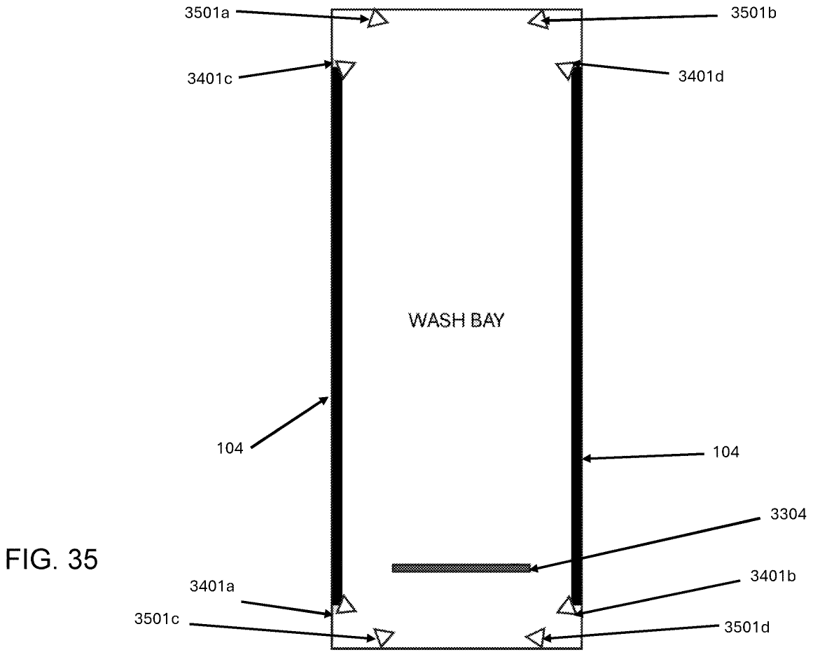

FIG. 35 is a top-down simplified view of the bay and cameras. Three-dimensional modeling cameras 3401a, 3401b, 3401c, 3401d are mounted to the ends of the robotic arm rails 104. Multiple surveillance cameras may be positioned throughout the bay to monitor its operation and send signals to the computer operating system that will trigger alarms/halt the system in the event that an anomaly is detected. For example, cameras 3501a, 3501b, 3501c, 3501d are mounted generally in the upper corners of the bay to provide full field of vision detection throughout the bay.

Although the present invention has been described in terms of various embodiments, it is to be understood that such disclosure is not intended to be limiting. Various alterations and modifications will be readily apparent to those of skill in the art. Accordingly, it is intended that the appended claims be interpreted as covering all alterations and modifications as fall within the spirit and scope of the invention.

What is claimed is:

1. A wash bay comprising:
a structure having a floor, a first wall and a second wall opposite the first wall,
a control computer system having inputs, outputs, memory and a computer processor;
a first robotic arm and a second robotic arm, each robotic arm being mounted to a respective one of the first and second walls and each adapted to move along the respective first and second walls according to instructions of the control computer
each of the first and second robotic arms comprising:
a proximal end and a distal end;
a plurality of multi-axis motors between the proximal end and distal end
a nozzle head connected to the distal end, the nozzle head including a plurality of nozzles;
a plurality of conduits adapted to supply liquids to at least one nozzle of the plurality of nozzles and air to at least one other nozzle of the plurality of nozzles;
a plurality of sensors adapted to detect the exterior shape of a vehicle positioned within the structure;
a set of predefined baseline paths stored in the memory that correspond to a first set of paths for the first robotic arm and a second set of paths for the second robotic arm;
wherein, the computer system is adapted to receive signals from the plurality of sensors, construct a simulated three-dimensional model based on the signals, formulate a set of prediction paths for each of the first robotic arm and second robotic arm based on the predefined baseline paths, process simulations of successive prediction paths with respect to the three-dimensional model and identify a set of target paths for each of the first robotic arm and second robotic arm, and control the operation of the robotic arms such that the nozzle heads of the robotic arms follow the target paths.
